(19) United States
(12) Patent Application Publication
(10) Pub. No.: US 2025/0044458 A1
(43) Pub. Date: Feb. 6, 2025

(54) System and Methods for Providing Anti-Spoofing Capability to a Global Navigation Satellite System Receiver

(71) Applicant: L3Harris Interstate Electronics Corporation, Anaheim, CA (US)

(72) Inventors: Derek Michael Loomer BOYER, Corona, CA (US); Steven B. ALEXANDER, Orange, CA (US); Richard F. REDHEAD, Mission Viejo, CA (US)

(21) Appl. No.: 18/586,935

(22) Filed: Feb. 26, 2024

Related U.S. Application Data
(63) Continuation of application No. 17/455,191, filed on Nov. 16, 2021, now Pat. No. 11,927,678.
Application No. 17/455,191 is a continuation of application No. 16/902,858, filed on Jun. 16, 2020, now Pat. No. 11,181,646.
Application No. 16/902,858 is a continuation of application No. 15/861,961, filed on Jan. 4, 2018, now Pat. No. 10,725,182.

(51) Int. Cl. G01S 19/21; G01S 19/03; G01S 19/24; G01S 19/36

(52) U.S. Cl. CPC G01S 19/215; G01S 19/03; G01S 19/36; G01S 19/24

(57) ABSTRACT

Apparatus and methods provide anti-spoofing capability from a first global navigation satellite system (GNSS) receiver to a second GNSS receiver. These GNSS receivers can be, for example, global positioning satellite (GPS) receivers. Via an authentication technique, signals from authentic GNSS sources are distinguished from signals from spoofers. Timing information, such as numerically-controlled oscillator (NCO) settings, used for tracking authenticated signals are then used to generate replica GNSS signals, which are then provided to the second GNSS receiver. As a result, the second GNSS receiver can provide accurate positioning system information in the presence of GNSS spoofers.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### CROSS-REFERENCE TO RELATED APPLICATION

This application is related to issued and co-owned application titled GLOBAL NAVIGATION SATELLITE SYSTEM SPOOFER IDENTIFICATION TECHNIQUE, U.S. Pat. No. 10,024,973, issued on Jul. 17, 2018, Ser. No. 14/678,755, filed on Apr. 3, 2015, the disclosure of which is hereby incorporated by reference in its entirety herein.

### BACKGROUND

### Field of the Invention

The invention generally relates to electronics, and in particular, to global navigation satellite system (GNSS) receivers.

### Description of the Related Art

The global positioning system (GPS) is an example of a global navigation satellite system (GNSS). A potential threat to the performance of a GNSS receiver is known as “spoofing.” Spoofing includes the transmission of false GNSS signals that can trick a GNSS receiver into incorrectly estimating its position, velocity, and/or time. One form of spoofing is known as “meaconing,” in which real GNSS signals are rebroadcast in a manner that causes the GNSS receiver to incorrectly estimate position, velocity, and/or time.

In addition, in certain situations, it can be difficult to upgrade or replace an existing GNSS receiver. For example, some GNSS receivers are custom-made or are built into objects such as vehicles. It would be desirable to provide a countermeasure to render these and other GNSS receivers to be less vulnerable to spoofing attacks.

### SUMMARY

One embodiment includes an apparatus including a first global navigation satellite system (GNSS) receiver for providing anti-spoofing capability to a second GNSS receiver, wherein the apparatus includes: a first group of acquisition and tracking functions configured to acquire and track multiple downconverted signals, wherein an acquisition and tracking function includes a hardware correlator; a processor configured to determine which of the multiple downconverted signals are based on authentic GNSS signals and which of the multiple downconverted signals are based on spoofed GNSS signals; and GNSS signal replicators configured to generate replicas of authentic GNSS signals based on timing settings used by the first group of acquisition and tracking functions to track the multiple downconverted signals that are based on authentic GNSS signals and not on timing settings used to track the multiple downconverted signals that are based on spoofed GNSS signals.

One embodiment includes a method for providing anti-spoofing capability from a first global navigation satellite system (GNSS) receiver a second GNSS receiver, wherein the method includes: acquiring and tracking multiple downconverted signals using a first group of acquisition and tracking functions, wherein an acquisition and tracking function includes a hardware correlator; determining which of the multiple downconverted signals are based on authentic GNSS signals and which of the multiple downconverted signals are based on spoofed GNSS signals; and using GNSS signal replicators, generating replicas of authentic GNSS signals based on timing settings used by the first group of acquisition and tracking functions to track the multiple downconverted signals that are based on authentic GNSS signals and not on timing settings used to track the multiple downconverted signals that are based on spoofed GNSS signals.

One embodiment includes an apparatus including a first global positioning system (GPS) receiver for providing anti-spoofing capability to a second GPS receiver, wherein the apparatus includes: a first group of acquisition and tracking functions configured to acquire and track multiple downconverted signals, wherein an acquisition and tracking function includes a hardware correlator; a processor configured to determine which of the multiple downconverted signals are based on authentic GPS signals and which of the multiple downconverted signals are based on spoofed GPS signals; and a means for generating replicas of authentic GPS signals based on timing settings used by the first group of acquisition and tracking functions to track the multiple downconverted signals that are based on authentic GPS signals and not on timing settings used to track the multiple downconverted signals that are based on spoofed GPS signals.

One embodiment includes an apparatus including a global navigation satellite system (GNSS) receiver with anti-spoofing capability, wherein the apparatus includes: a beamformer having an output with a group of downconverted signals corresponding to a spot beam antenna pattern; a group of acquisition and tracking functions configured to acquire and track multiple downconverted signals, wherein an acquisition and tracking function includes a hardware correlator; and a processor configured to determine which of the multiple downconverted signals are based on authentic GNSS signals and which of the multiple downconverted signals are based on spoofed GNSS signals, wherein the processor is configured to determine that a downconverted signal is from an authentic space vehicle when a spot beam antenna pattern nominally pointed towards a location in space of a corresponding space vehicle is dithered and a signal strength of the downconverted signal varies in an expected manner with dithering of the spot beam antenna pattern, wherein the processor is further configured to determine position based on the multiple downconverted signals that are based on the authentic GNSS signals and not on the multiple downconverted signals that are based on spoofed GNSS signals.

One embodiment includes a method for providing a global navigation satellite system (GNSS) receiver with anti-spoofing capability, wherein the method includes: using a beamformer, generating an output with a group of downconverted signals corresponding to a spot beam antenna pattern; acquiring and tracking multiple downconverted signals using the group of acquisition and tracking functions, wherein an acquisition and tracking function includes a hardware correlator; determinining which of the multiple downconverted signals are based on authentic GNSS signals and which of the multiple downconverted signals are based on spoofed GNSS signals, wherein a downconverted signal is determined to be based on a signal from an authentic space vehicle when a spot beam antenna pattern nominally pointed towards a location in space of a corresponding space vehicle is dithered and a signal strength of the downconverted signal varies in an expected manner with dithering of the spot beam antenna pattern; and determining position based on the multiple downconverted signals that are based on the authentic GNSS signals and not on the multiple downconverted signals that are based on spoofed GNSS signals.

### BRIEF DESCRIPTION OF THE DRAWINGS

These drawings and the associated description herein are provided to illustrate specific embodiments of the invention and are not intended to be limiting.

FIG. 1 illustrates an embodiment of an antenna and a GNSS receiver that can provide anti-spoofing capability to a second GNSS receiver via simulated GNSS signals. A beamformer provides a non-directional pattern output and a spot beam antenna pattern output.

FIG. 2 illustrates the embodiment of FIG. 1 with the addition of anti-jamming processing.

FIG. 3 illustrates an embodiment of an antenna and a GNSS receiver that can provide anti-spoofing capability to a second GNSS receiver via simulated GNSS signals. A beamformer provides a spot beam antenna pattern output.

FIG. 4 illustrates the embodiment of FIG. 3 with the addition of anti-jamming processing.

FIG. 5 illustrates an embodiment of an antenna and a GNSS receiver that can provide anti-spoofing capability to a second GNSS receiver via simulated GNSS signals. A beamformer provides multiple spot beam antenna pattern outputs.

FIG. 6 illustrates the embodiment of FIG. 5 with the addition of anti-jamming processing.

FIG. 7 illustrates a process for generating simulated or replica GNSS signals.

FIG. 8 illustrates a process for determining whether a signal originated from an authentic space vehicle source or originated from a spoofer.

FIG. 9 illustrates an integrated antenna and GNSS receiver.

FIG. 10 illustrates a separate antenna and GNSS receiver.

FIG. 11 illustrates an embodiment of an adapter for powering a GNSS receiver with anti-spoofing and providing simulated GNSS signals to a second GNSS receiver.

FIG. 12 illustrates an embodiment configured to provide simulated GNSS signals to multiple GNSS receivers.

To avoid repetition of description, components having the same or similar function may be referenced by the same reference number.

### DETAILED DESCRIPTION OF SPECIFIC EMBODIMENTS

Although particular embodiments are described herein, other embodiments, including embodiments that do not provide all of the benefits and features set forth herein, will be apparent to those of ordinary skill in the art.

Accurate reporting of position, velocity, and time are indeed desirable attributes of any GNSS receiver. While illustrated in the context of the NAVSTAR Global Positioning System (GPS), the principles and advantages described herein are applicable to other GNSS, such as, but not limited to, the Russian GLONASS system, the European Galileo system, the Chinese COMPASS system, the Indian IRNSS system, or the like.

GNSS receivers include, but are not limited to, navigation systems, surveying and mapping equipment, flight data recorders and other vehicle tracking equipment, Aircraft Communications Addressing and Reporting System (ACARS), and the like. Various types of objects can rely on the GNSS-based information. These objects can include, but are not limited to smart phones, cars, trucks, aircraft, gliders, helicopters, watercraft, driverless or autonomous motor vehicles, unmanned aerial vehicles (UAVs), guided missiles, cruise missiles, smart bombs, artillery, robots, farm equipment, network equipment, decoys, transponders, and the like. If a GNSS receiver for these objects were to incorrectly report information, undesirable events can occur to the object relying on the GNSS-based information, such as getting lost or thrown off course, incorrectly fertilizing a field, getting into accidents or crashes, incorrectly reporting position, velocity, and/or time in log entries, incorrectly synchronizing transmission of data, incorrectly mapping a region, or the like.

One embodiment of the invention can advantageously provide one or more countermeasures against spoofers. One embodiment identifies a direction from which a spoofing attack occurs. A beamformer can control an antenna pattern of a controlled reception pattern antenna (CRPA) to generate a variety of antenna patterns, such as directional patterns with a main lobe and/or to generate one or more nulls for a pattern that may or may not be directional. For example, a variety of different antenna patterns can be selected for beam steering or for null steering. These different antenna patterns can vary by, for example, applying different phase shifts for the signals from the elements of the CRPA. Parameters for antenna patterns, such as phase shift information, can be generated during a calibration operation and can be stored in lookup tables for access during operation and can also be generated during use using space-time adaptive processing (STAP) and/or space-frequency adaptive processing (SFAP).

With digital beamforming, many different antenna patterns can be generated at the same time. The different antenna patterns are generated via different patterns of constructive and destructive interference. When a directional antenna pattern is generated by the beamformer, the antenna pattern exhibits gain along the direction of the main lobe. A beam can be steered by changing the antenna pattern to one that has the main lobe along a different direction. When a null is generated by the beamformer, the antenna pattern exhibits attenuation or loss along the direction of the null. The nulls can also be steered by changing the antenna pattern from among various antenna patterns having nulls.

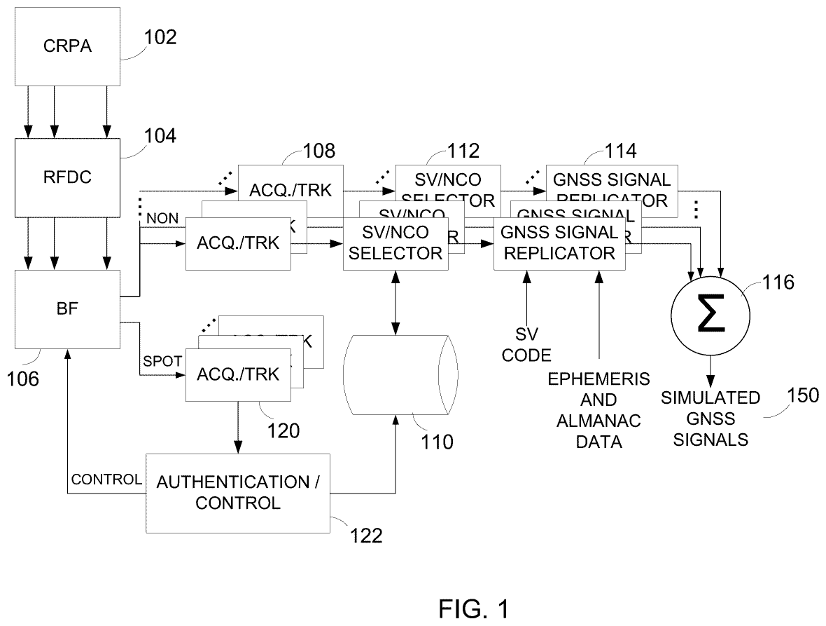

FIG. 1 illustrates an embodiment of an antenna 102 and components of a first GNSS receiver that can provide anti-spoofing capability to a second GNSS receiver via simulated GNSS signals 150. The second GNSS receiver can be a legacy GNSS receiver that does not inherently possess anti-spoofing capability. In certain embodiments, such as when the first GNSS receiver is only being use to provide anti-spoofing capability to the second GNSS receiver, the first GNSS receiver does not have to be a complete GNSS receiver and for example, does not need to provide a GNSS-based position, velocity, and time (PVT) solution as the PVT solution will be performed by the second GNSS receiver. However, for a standalone GNSS receiver, the capability to provide PVT can be readily added by those of ordinary skill in the art.

The antenna 102 can correspond to a controlled reception pattern antenna (CRPA). An RFDC block 104 of the illustrated GNSS receiver can include, for example, low noise amplifiers (LNAs), radio frequency (RF) downconverters, and analog-to-digital converters (ADCs). RF signals from each antenna element of the antenna 102 are amplified and downconverted by the LNAs and downconverters to generate intermediate frequency (IF) signals. The IF signals are then converted to digital form by the ADCs to generate digital IF signals. In the context of military GPS receivers utilizing both L1 and L2 bands, a digital IF signal downconverted from L1 and a digital IF signal downconverted from L2 can be generated for each antenna element. In the context of GPS, since the various signals from the various space vehicles (SVs) are broadcast at the same frequencies, these digital IF signals typically carry multiple digital downconverted signals. An advantage of using digital IF signals is that multiple independent antenna patterns/beams can be formed by a beamformer (BF) 106 from the signals originating from the antenna 102.

In the embodiment illustrated in FIG. 1, the beamformer 106 provides a non-directional pattern output and a spot beam antenna pattern output. In this example, the multiple downconverted signals from the non-directional pattern output are used for providing GNSS signal replication. The multiple downconverted signals from the spot beam antenna pattern output are used for identifying which of the multiple downconverted signals are based on authentic SV signals and which are based on spoofed signals.

In the context of GPS, the SVs broadcast their signals at the same frequencies. While these frequencies will be altered a bit by Doppler shift, multiple downconverted signals from multiple SV RF signals and possibly RF signals from spoofers can exist when received. Different SVs modulate their RF signals using different spreading codes or pseudo-random noise (PRN) codes such that a GPS receiver can distinguish among the signals. However, a spoofer will broadcast its signals using the same spreading codes as the SVs. A meaconer type of spoofer can take authentic signals from SVs and rebroadcast them with delays. It can be difficult for a conventional GPS receiver to distinguish between authentic and spoofed signals, which can lead to undesirable results, such as miscalculations of position.

The multiple downconverted signals from the non-directional pattern output are provided as an input to multiple acquisition and tracking functions 108. These acquisition and tracking functions 108 should be numerous enough to acquire and track both downconverted signals based on authentic RF SV signals and acquire and track downconverted signals based on spoofed RF signals. Acquisition and tracking of PRN codes is well known in the art and involves synchronizing a replica code for a SV with the signal (or downconverted version of the signal) received. After a signal is acquired and is being tracked, the timing required for synchronization with the replica code will be known. This timing information, which can be numerically-controlled oscillator (NCO) timing, can be the basis for reconstruction of a clean version of the GNSS signals, that is, a version without spoofing. These acquisition and tracking functions can include a combination of hardware and software. An example of hardware can include a correlator circuit, which is also known as a digital matched filter. Much of the control function, however, is typically implemented using firmware/software instructions executed by a processor.

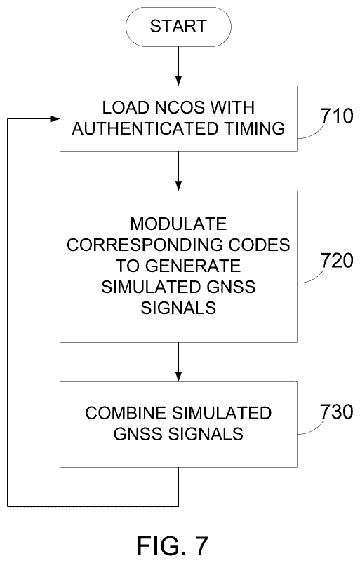

Using techniques to be described later, the acquired and tracked downconverted signals are characterized as being authentic or spoofed. For example, NCO timing and the characterization can be stored in a memory device 110. A selector 112, which can be implemented by software, can pass identifiers for the relevant replica codes and the corresponding NCO timings to GNSS signal replicators 114 for only the authenticated signals. The GNSS signal replicators can modulate the SV replica code, such as coarse acquisition (C/A) codes and precise P(Y) codes onto an RF carrier, such as via binary phase-shift keying (BPSK) modulation. Other codes, such as military (M) codes exist and will also be applicable. The almanac data and the relevant ephemeris data for the SV can also be included in the modulation. This can be performed in a similar manner as is actually done in a SV. Other techniques can apply. The ephemeris data and almanac data can be retrieved from the authentic GNSS signals via the navigation message or can be retrieved from a different source, such as a computer network. The various modulated RF signals are then combined 116 and can be provided as an input to the second GNSS receiver to provide the second GNSS receiver with anti-spoofing capability. The RF combining technique is not critical as the RF signal power can be relatively low. A process for generating simulated or replica GNSS signals will be described later in connection with FIG. 7.

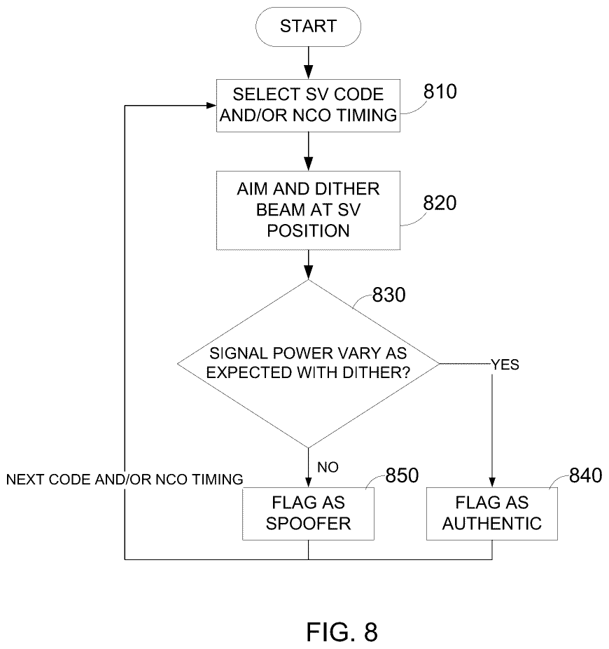

In the embodiment illustrated in FIG. 1, the multiple downconverted signals from the spot beam antenna pattern output of the beamformer 106 are provided as an input to multiple acquisition and tracking functions 120. The spot beam antenna pattern is used for identifying which of the multiple downconverted signals are based on authentic SV signals and which are based on spoofed signals. One technique to detect spoofers is described in copending and co-owned U.S. patent application Ser. No. 14/678,755, filed on Apr. 3, 2015. Another technique will be described in greater detail later in connection with FIG. 8. Other techniques may also be applicable. The characterization of signals as being based on authentic signals or spoofed signals can be repeatedly performed to maintain updated anti-spoofing. The authentication/control block 122 can perform the particular spoofing detection technique and provide the results to the memory device 110.

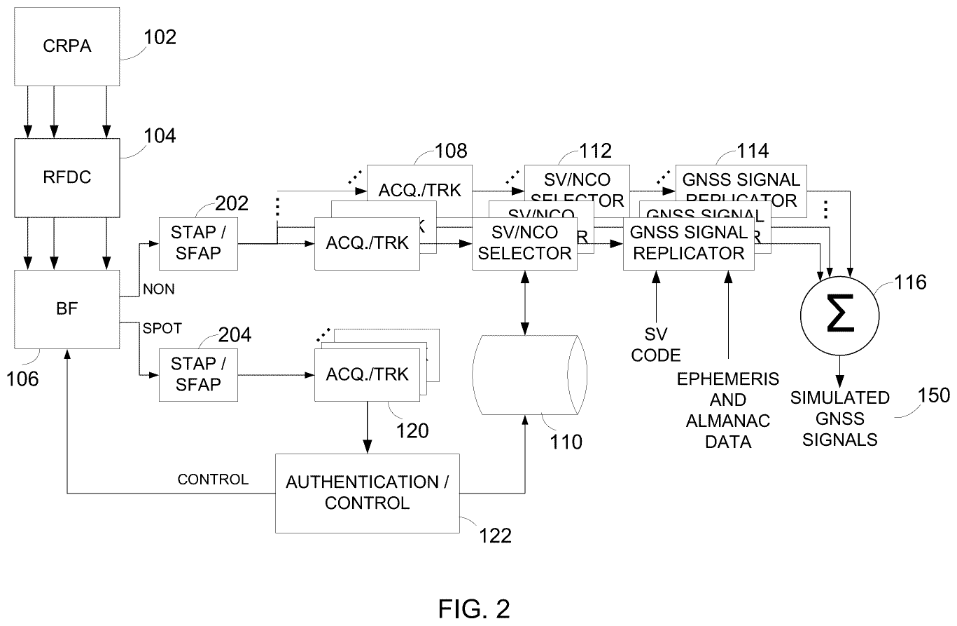

FIG. 2 illustrates the embodiment of FIG. 1 with the addition of anti-jamming processing. For example, space-time adaptive processing (STAP) or space-frequency adaptive processing (SFAP) techniques can be used to provide anti-jam capability. As illustrated in FIG. 2, a first STAP or SFAP processor 202 is disposed in a signal path between the non-directional antenna pattern output of the beamformer 106 and an input of the group of acquisition and tracking functions 108, and a second STAP or SFAP processor is disposed in a signal path between the spot beam antenna pattern output of the beamformer 106 and an input of the group of acquisition and tracking functions 120.

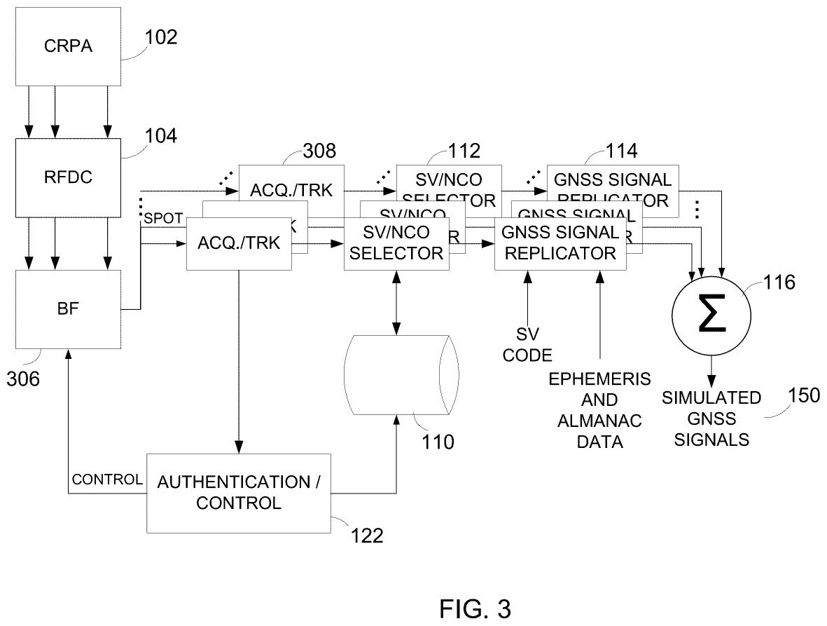

FIG. 3 illustrates an embodiment of an antenna 102 and a GNSS receiver that can provide anti-spoofing capability to a second GNSS receiver via simulated GNSS signals. To avoid repetition of description with that of FIG. 1, components having the same or similar function may be referenced by the same reference number.

Unlike the embodiment of FIG. 1, the beamformer 306 does not have a non-directional antenna pattern output. The beamformer 306 provides a spot beam antenna pattern output. The spot beam antenna pattern output is provided as an input to multiple acquisition and tracking functions 308. The spot beam antenna pattern output is used for both reconstruction of a clean GNSS signal and for distinguishing authentic signals from spoofed signals. As will be explained in greater detail later in connection with FIG. 8, the spot beam can be pointed at particular locations in space where the SVs are supposed to be in order to distinguish between authentic and spoofed signals. While the spot beam may not be pointed towards other SVs, there should be enough energy received to maintain acquisition and tracking with the other SV signals.

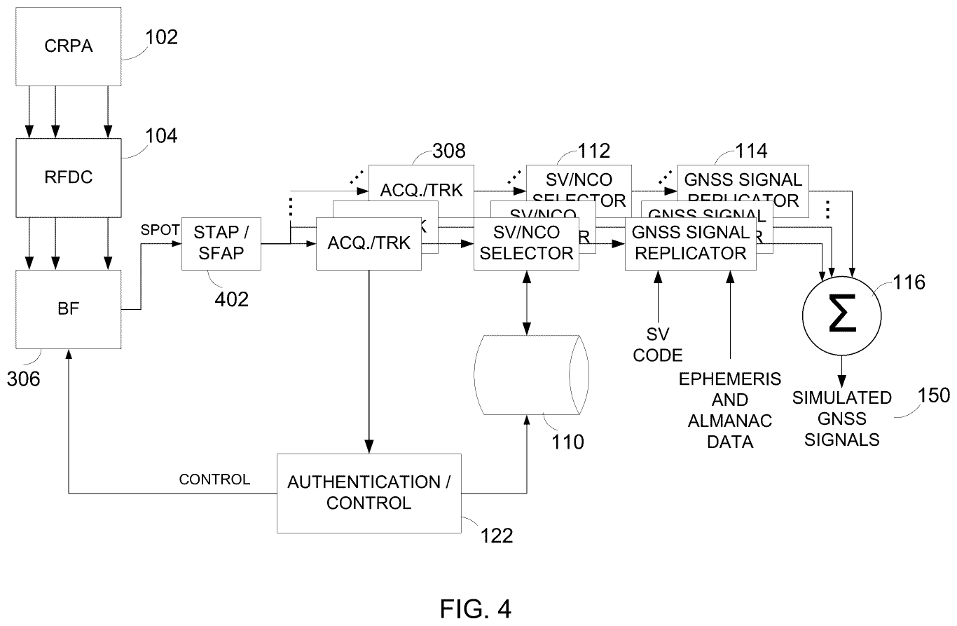

FIG. 4 illustrates the embodiment of FIG. 3 with the addition of anti-jamming processing. As illustrated in FIG. 4, a STAP or SFAP processor 402 is disposed in a signal path between the spot beam antenna pattern output of the beamformer 306 and an input of the group of acquisition and tracking functions 308.

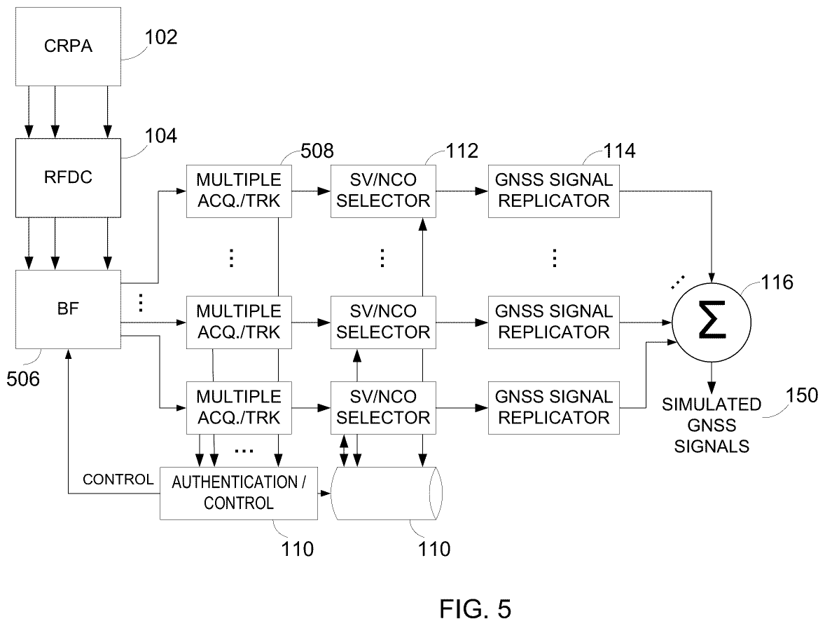

FIG. 5 illustrates an embodiment of an antenna 102 and a GNSS receiver that can provide anti-spoofing capability to a second GNSS receiver via simulated GNSS signals. In the embodiment of FIG. 5, the beamformer 506 generates multiple spot beam antenna patterns. These multiple spot beam antenna patterns can advantageously provide gain in the direction of the SVs to provide additional anti-spoofing and anti-jamming capability over the embodiment described in connection with FIG. 3.

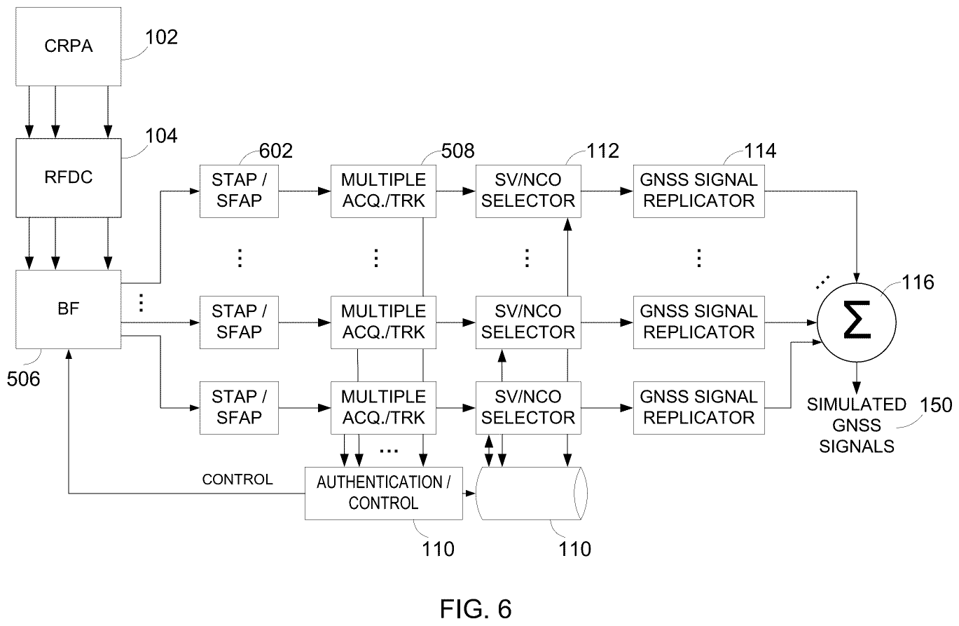

FIG. 6 illustrates the embodiment of FIG. 5 with the addition of anti-jamming processing. As illustrated in FIG. 6, STAP or SFAP processors 602 are disposed in signal paths between the various spot beam antenna pattern outputs of the beamformer 306 and inputs of the groups of acquisition and tracking functions 508.

FIG. 7 illustrates a process for generating simulated or replica GNSS signals. After the authenticated signals are identified, the timing information from these signals, such as NCO timing, is used to reconstruct clean GNSS replica signals. In a state 710, the NCOs that control the timing of code chips for SV PRN codes are loaded with the timing information from the authentic GNSS signals. In a state 720, these codes, such as, but not limited to, C/A codes and P(Y) codes, are modulated onto RF carriers to generate simulated GNSS signals. In a state 730, the various simulated GNSS signal are combined. The process can be repeated as desired. The second GNSS receiver can advantageously receive this clean GNSS replica signal and accurately provide PVT information even in the presence of spoofers.

FIG. 8 illustrates a process for determining whether a signal originated from an authentic space vehicle source or originated from a spoofer. While illustrated sequentially, the process can alternatively be performed in parallel for multiple signals from multiple SVs. The process begins with a selection of a particular SV code 810 with a particular timing. As described earlier, in the presence of a spoofer, multiple signals having the same SV code can be present. A spot beam from the beamformer is aimed or pointed towards a point in space where the particular SV is supposed to be. The location of a particular SV can be obtained from its ephemeris data. The aiming of the spot beam is then dithered 810 or moved around that point in space, and the signal power is monitored to see if it varies as expected 830. An authentic signal from a space vehicle will vary in power, such as carrier-to-noise ratio, as the spot beam is dithered. This variance can vary in a broad range based on beam width, the number of elements in the CRPA, etc. However, the expected amount of variance will be readily determined by one of ordinary skill in the art. By contrast, the signal from a spoofer on the ground will not vary as much as the beam is dithered.

If the signal power varies as expected, the process determines that the signal is authentic and can flag that signal as authentic. If the signal power does not vary as expected, the process determines that the signal originates from a spoofer and can flag that signal as spoofed or untrustworthy. These determination can be used in reconstructing clean replica signals for a second GNSS receiver or for providing anti-spoofing capability in a standalone GNSS receiver. The process can be repeated for other signals of the same code but with different NCO timings and/or for other codes. These techniques can be implemented by execution of software modules by a computer hardware system. Instructions for the software can be stored in a tangible, computer-readable medium.

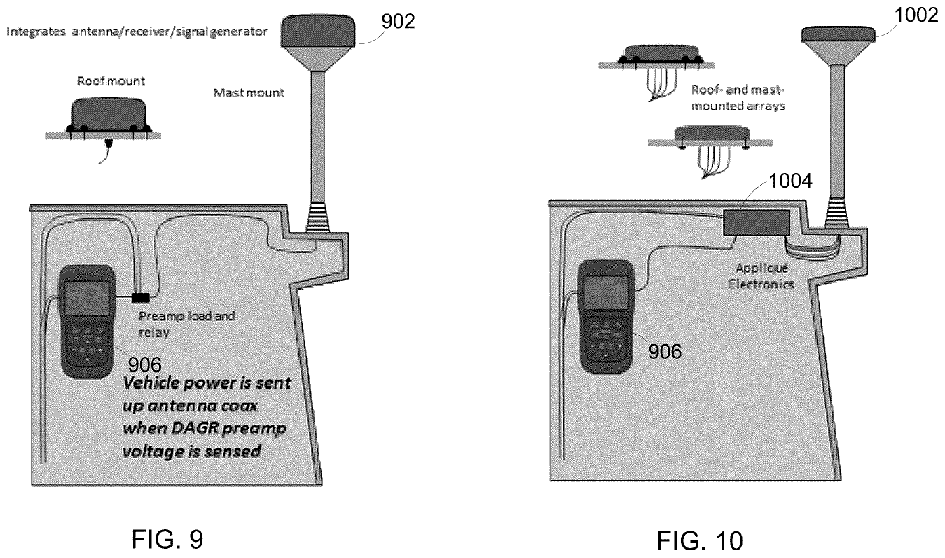

FIG. 9 illustrates an integrated antenna and GNSS receiver 902. FIG. 10 illustrates a separate antenna 1002 and GNSS receiver 1004. The clean simulated GNSS replica signals can be provided to the second GNSS receiver 906.

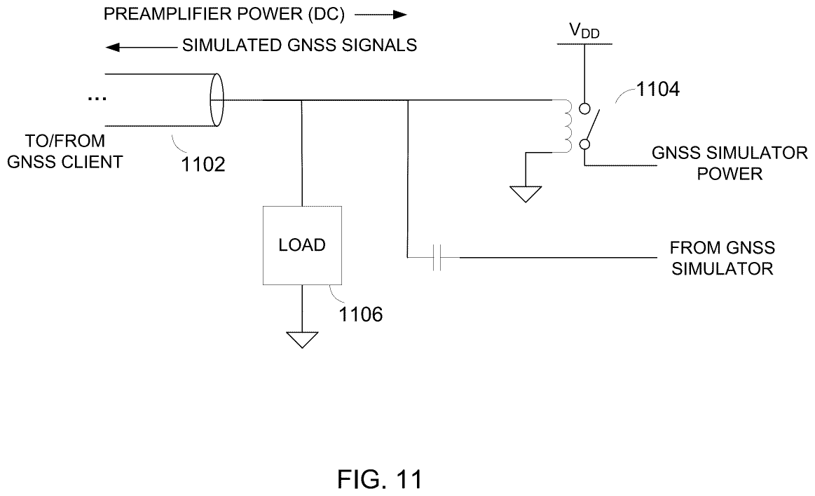

FIG. 11 illustrates an embodiment of an adapter for powering a GNSS receiver with anti-spoofing and providing simulated GNSS signals to a second GNSS receiver. An antenna input port 1102 for the second GNSS receiver 906 can be used for both receiving GNSS signals and for providing preamplifier power. Of course, the simulated GNSS signals can be provided to the second GNSS receiver 906 via the antenna input port, but the preamplifier output can also be used to power a relay 1104 for powering of the GNSS receiver with anti-spoofing, as the power intended for a preamplifier can be insufficient to power up a GNSS receiver. A load 1106 can be provided for RF matching. A capacitor 1108 can be used to isolate DC power and RF signals.

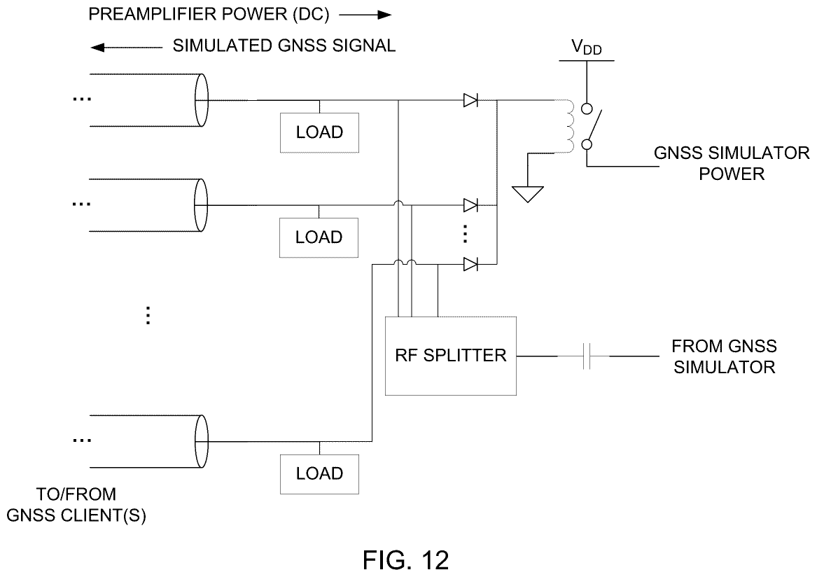

FIG. 12 illustrates an embodiment of an adapter for powering multiple GNSS receivers with anti-spoofing and providing simulated GNSS signals to multiple GNSS receivers. Antenna input ports for the GNSS receivers can be used for both receiving GNSS signals and for providing preamplifier power. The simulated GNSS signals can be provided to a given GNSS receiver via a respective antenna input port, and optionally the preamplifier output can also be used to power a relay for powering of the given GNSS receiver with anti-spoofing. A load can be provided for each antenna input port for RF matching. Each antenna input port may be connected to an RF splitter so that the signal from the GNSS simulator may be shared by the multiple GNSS receivers. A capacitor can be used to isolate DC power and RF signals.

Various embodiments have been described above. Although described with reference to these specific embodiments, the descriptions are intended to be illustrative and are not intended to be limiting.

What is claimed is:

1. An apparatus comprising a first global navigation satellite system (GNSS) receiver configured to provide anti-spoofing capability, the apparatus comprising:
an acquisition and tracking circuit comprising at least a correlator, the acquisition and tracking circuit configured to track a plurality signals;
a processor configured to determine which of the plurality of signals are based on authentic GNSS signals and which of the plurality of signals are based on spoofed GNSS signals;
a beamformer at least partially controlled by the processor, wherein the beamformer has at least a first output with a first group of signals and a second output with a second group of signals, wherein the first output corresponds to a first antenna pattern and the second output corresponds to a second antenna pattern different than the first antenna pattern, wherein the first group of signals is provided as an input to the acquisition and tracking circuit; and
wherein the processor is configured to determine whether a particular signal is based on an authentic GNSS signal or on a spoofed GNSS signal based at least in part on determining whether the particular signal is behaving as expected with respect to a space vehicle.

2. The apparatus of claim 1, the apparatus further comprising GNSS signal replicators configured to generate replicas of authentic GNSS signals based on timing settings used to track the plurality of signals that are based on authentic GNSS signals, wherein the timing settings comprise numerically controlled oscillator (NCO) settings.

3. The apparatus of claim 1, wherein the GNSS comprises a global positioning system (GPS), wherein the plurality of signals comprise at least a first authentic signal and a second spoofed signal, wherein both the first authentic signal and the second spoofed signal have different timing offsets and are both independently tracked by the acquisition and tracking circuit.

4. The apparatus of claim 1, wherein the apparatus is configured to determine that a given signal is from an authentic space vehicle at least partly in response to determining, when a spot beam antenna pattern nominally pointed towards a location in space of a corresponding space vehicle has a change in an orientation of a corresponding gain pattern, that a signal strength of the given signal varies in an expected manner with the orientation of the spot beam antenna pattern.

5. The apparatus of claim 1, the apparatus further comprising a space-time adaptive processor or a space-frequency adaptive processor disposed in a signal path between at least one beamformer output and the input of the acquisition and tracking circuit.

6. The apparatus of claim 1, wherein the beamformer is configured to provide a non-directional antenna pattern output.

7. The apparatus of claim 1, wherein an orientation of an antenna gain pattern is varied using dithering.

8. A method for providing anti-spoofing capability by a first global navigation satellite system (GNSS) receiver, the method comprising:
acquiring and tracking multiple signals using a first acquisition and tracking circuit;
determining:
which of the multiple signals are based on authentic GNSS signals, and
which of the multiple signals are based on spoofed GNSS signals;
wherein the GNSS comprises a global positioning system (GPS), and
wherein the multiple signals comprise at least a first authentic signal and a second spoofed signal,
independently tracking the first authentic signal and the second spoofed signal,
wherein the first authentic signal and the second spoofed signal have different timing offsets.

9. The method of claim 8, the method further comprising determining that a signal is from an authentic space vehicle at least partly in response to determining that a signal strength of the signal varies in an expected manner with movement of a beam antenna pattern when a beam antenna pattern nominally pointed towards a location in space of a corresponding space vehicle is moved.

10. The method of claim 8, the method further comprising:
using a beamformer, generating at least a first output with a first group of signals, wherein the first output corresponds to a non-directional antenna pattern, wherein the first group of signals is provided as an input to the first acquisition and tracking circuit;
providing first anti-jam processing in a first signal path between the first output of the beamformer and an input of the first acquisition and tracking circuit.

11. A method for providing anti-spoofing capability by a first global navigation satellite system (GNSS) receiver, the method comprising:
acquiring and tracking multiple signals;
determining which of the multiple signals are based on authentic GNSS signals and which of the multiple signals are based on spoofed GNSS signals;
using a beamformer, generating multiple outputs corresponding to multiple antenna patterns;
receiving groups of signals corresponding to the multiple antenna patterns; and
generating replicas of authentic GNSS signals based on timing settings used to acquire and track the multiple signals.

12. The method of claim 11, the method further comprising performing anti-jam processing in signal paths between outputs of the beamformer and inputs of an acquisition and tracking circuit.

13. The apparatus of claim 11, wherein an orientation of the multiple antenna pattern orientation is varied using dithering.

14. A method for providing anti-spoofing capability by a first global navigation satellite system (GNSS) receiver, the method comprising:
acquiring and tracking multiple signals;
determining which of the acquired multiple signals are based on authentic GNSS signals and which of the multiple signals are based on spoofed GNSS signals;
generating replicas of authentic GNSS signals based on timing settings used in acquiring and tracking the multiple signals that are based on authentic GNSS signals; and
using a beamformer, generating at least an output with a group of signals, wherein the output corresponds to a first antenna pattern; and
monitoring at least one characteristic of the group of signals; and
based at least in part on the monitored at least one characteristic of the group of signals, determining whether a particular monitored signal is based on an authentic GNSS signal or on a spoofed GNSS signal.

15. The method of claim 14, the method further comprising determining that a signal is from an authentic space vehicle at least partly in response to determining that a signal strength of the signal varies in an expected manner with dithering of an antenna pattern when the antenna pattern nominally pointed towards a location in space of a corresponding space vehicle is dithered.

16. The method of claim 14, the method further comprising performing anti-jam processing on a signal in a path from the output of the beamformer and an input of an acquisition and tracking circuit.

17. The method of claim 14, wherein the at least one characteristic of the group of signals comprises power.

18. The method of claim 14, wherein the at least one characteristic of the group of signals comprises carrier-to-noise ratio.

19. The method of claim 14, the method further comprising varying the first antenna pattern orientation using dithering.

20. A method, the method comprising:
selecting, using a processor, a first space vehicle code and/or a first oscillator timing;
forming and aiming a beam using a beamformer, wherein the beam is aimed towards a point in space where a space vehicle associated with the first space vehicle code is expected;
dithering or moving the beam around the point in space where the space vehicle is expected;
monitoring a signal that appears to be from the space vehicle while the beam is being dithered or moved around the point in space where the space vehicle is expected;
determining if the signal being monitored while the beam is being dithered or moved around the point in space where the space vehicle is varying as expected for the space vehicle;
at least partly in response to determining that the signal being monitored while the beam is being dithered or moved around the point in space where the space vehicle is not varying as expected, determining that the signal is from a spoofer and/or untrustworthy; and
at least partly in response to determining that the signal is from a spoofer and/or untrustworthy, generating a corresponding indication that the signal is from a spoofer and/or untrustworthy.

21. The method of claim 20, the method further comprising using the determination that the signal is from a spoofer and/or untrustworthy in providing anti-spoofing capabilities.

22. The method of claim 20, the method further comprising using the first oscillator timing to generate a reconstruction of a clean version of a GNSS signal without spoofing.

23. The method of claim 20, the method further comprising using the determination that the signal is from a spoofer and/or untrustworthy in providing anti-spoofing capabilities.

24. The method of claim 20, the method further comprising:
selecting a second oscillator timing;
forming and aiming a second beam using the beamformer, wherein the second beam is aimed towards a second point in space where the space vehicle associated with the first space vehicle code is expected;
dithering or moving the second beam around the second point in space where the space vehicle is expected;
monitoring a signal that appears to be from the space vehicle while the second beam is being dithered or moved around the second point in space where the space vehicle is expected;
determining if the signal being monitored while the second beam is being dithered or moved around the second point in space where the space vehicle is varying as expected for the space vehicle;
at least partly in response to determining that the signal being monitored while the second beam is being dithered or moved around the second point in space where the space vehicle is varying as expected, determining that the signal is authentic; and
at least partly in response to determining that the signal is authentic, generating a corresponding indication that the signal is authentic.

25. The method of claim 20, wherein the method is performed using a GNSS receiver comprising a downconverter, a correlator, an acquisition and tracking processor, and a GNSS signal replicator.

26. The method of claim 20, the method further comprising forming at least one beam using space-frequency adaptive processing.
